(19) United States
(12) Patent Application Publication
(10) Pub. No.: US 2025/0224300 A1
(43) Pub. Date: Jul. 10, 2025

(54) TEST BENCH FOR IMPACT LEAKAGE DETECTION OF WATER HYDRAULIC CYLINDER BASED ON HELIUM GAS DETECTION

(71) Applicant: SHANDONG UNIVERSITY OF SCIENCE AND TECHNOLOGY, Qingdao (CN)

(72) Inventors: Qiang ZHANG, Qingdao (CN); Jiyang YU, Qingdao (CN); Hengxuan LUAN, Qingdao (CN); Feng ZHOU, Qingdao (CN); Chunyong FAN, Qingdao (CN); Hong ZHANG, Qingdao (CN); Bofeng CHANG, Qingdao (CN); Xin LIU, Qingdao (CN); Chengjian YUAN, Qingdao (CN); Chenglong WANG, Qingdao (CN); Ya LIU, Qingdao (CN); Chao ZHANG, Qingdao (CN); Yunjie PENG, Qingdao (CN); Yongrui YANG, Qingdao (CN); Wenchun JIANG, Qingdao (CN)

(21) Appl. No.: 19/019,706

(22) Filed: Jan. 14, 2025

Related U.S. Application Data
(63) Continuation of application No. PCT/CN2024/077863, filed on Feb. 21, 2024.

(30) Foreign Application Priority Data
Jan. 10, 2024 (CN) 202410036870.8

(51) Int. Cl. G01M 3/22; G01M 3/20

(52) U.S. Cl. CPC G01M 3/226; G01M 3/202

(57) ABSTRACT

A test bench for impact leakage detection of a water hydraulic cylinder based on helium gas detection includes a test bench body, a water hydraulic cylinder, a helium bottle, a sealed container, and an impact device. The water hydraulic cylinder is detachably installed on the test bench body; an outlet end of the helium bottle is in communication with a rodless cavity of the water hydraulic cylinder, and a pressure reducing valve is installed between the helium bottle and the water hydraulic cylinder; the sealed container is detachably installed at a rod cavity of the water hydraulic cylinder, and a helium mass spectrometer leak detector is installed on the sealed container; and the impact device is fixedly installed on the test bench body, and the impact device is connected to a piston rod of the water hydraulic cylinder.

### CROSS-REFERENCE TO RELATED APPLICATIONS

This application is a continuation of PCT/CN2024/077863, filed Feb. 21, 2024 and claims priority of Chinese Patent Application No. 202410036870.8, filed on Jan. 10, 2024, the entire contents of which are incorporated herein by reference.

### TECHNICAL FIELD

The present disclosure relates to the technical field of test devices, and in particular to a test bench for impact leakage detection of a water hydraulic cylinder based on helium gas detection.

### BACKGROUND

Water hydraulic technology is a kind of hydraulic transmission technology with water as working medium, which has the advantages of green and environmental protection. Water hydraulic technology has a broad application prospect in the fields with strict environmental pollution requirements such as food, beverage, medicine, electronics, packaging, etc., as well as in the high-temperature open flame environment such as metallurgy, hot rolling and casting, and in the research field of high-pressure and super-large-flow water hydraulic components for mining.

The development of water hydraulic technology has a history of more than 200 years. From the 1960 s, when the U.S. military carried out research on underwater working tools, the water hydraulic transmission technology has developed for half a century. In China, since the early 1980s, there have been universities and research institutes to carry out research on hydraulic transmission technology.

In the development of hydraulic technology, due to the two serious shortcomings of flammability and pollution of hydraulic oil, hydraulic transmission is not only difficult to promote and apply in industries such as food, beverage, medicine, electronics, and packaging, but also gradually loses its advantages in the high-temperature open flame environment such as metallurgy, hot rolling and casting, and flammable and explosive environments such as coal mines. Therefore, the emergence of water hydraulic technology is of great significance to make up for the shortcomings of hydraulic technology.

Because of the low viscosity of water, water will have a great impact on the hydraulic cylinder and other components, so it is necessary to detect the leakage of the hydraulic cylinder under the impact conditions. The existing test impact devices mainly adopt drop hammer impact loading test system, accumulator rapid loading test system, blasting impact loading test system, etc. The drop hammer impact loading test system may simulate real working conditions well, but the pressure signal of the heavy object may not be accurately controlled, which is not conducive to the acquisition of experimental data. The instability of blasting impact loading test system leads to poor controllability of pressure signal. The accumulator rapid loading test system has the advantages of fast loading speed, high economy, easy data acquisition and high controllability.

In the traditional detection methods of the sealing performance of hydraulic cylinder, bubble method, smear method and pressure gauge method are often used. However, these methods have some shortcomings, such as complicated operation, low precision and easy to be disturbed by the environment. In order to meet the requirements of higher accuracy and efficiency, helium gas detection method is gradually introduced into the detection of the sealing performance of hydraulic cylinder. Helium gas detection method has the advantages of high sensitivity, fast detection speed and non-contact. This method uses helium as a tracer gas to detect the scaling performance of the hydraulic cylinder through special detection equipment. When there is a leak in the hydraulic cylinder, helium will quickly diffuse into the surrounding environment and be captured and measured for the leakage amount by the detection equipment. Through comparative analysis, the sealing performance of hydraulic cylinder may be determined.

The traditional helium detection method is to fill the hydraulic cylinder with helium and put the hydraulic cylinder in a sealed cavity, and detect the sealing performance of the hydraulic cylinder by detecting the helium content in the sealed container. However, for the detection of hydraulic cylinder sealing performance under impact conditions, putting the whole test bench in a sealed container will make the impact difficult to realize, the sealed cavity is too large and inconvenient and easily affected by other factors inside the cavity, making it difficult to detect. Only putting the tested hydraulic cylinder into the sealed container and placing the impact source outside the sealed container will lead to scaling difficulties and inaccurate results. Therefore, a test bench is designed to realize the detection of the sealing performance of water hydraulic cylinder under impact conditions.

### SUMMARY

An objective of the present disclosure is to provide a test bench for impact leakage detection of a water hydraulic cylinder based on helium gas detection, so as to solve the problems existing in the prior art.

In order to achieve the above objective, the present disclosure provides a test bench for impact leakage detection of a water hydraulic cylinder based on helium gas detection, including:
a test bench body;
a water hydraulic cylinder, where the water hydraulic cylinder is detachably installed on the test bench body;
a helium bottle, where an outlet end of the helium bottle is in communication with a rodless cavity of the water hydraulic cylinder, and a pressure reducing valve is installed between the helium bottle and the water hydraulic cylinder;
a sealed container, where the sealed container is detachably installed at a rod cavity of the water hydraulic cylinder, and a helium mass spectrometer leak detector is installed on the sealed container; and
an impact device, where the impact device is fixedly installed on the test bench body, and the impact device is connected to a piston rod of the water hydraulic cylinder, and the impact device is used for providing impact power for the water hydraulic cylinder.

In an embodiment, the impact device includes:
an oil tank;
an oil hydraulic cylinder, where the oil hydraulic cylinder is detachably installed on the test bench body, and a piston rod of the oil hydraulic cylinder is connected to the piston rod of the water hydraulic cylinder;
a second hydraulic pump, where an inlet end of the second hydraulic pump is in communication with the oil tank, and an outlet end of the second hydraulic pump is sequentially provided with a first one-way valve and a two-position three-way solenoid directional valve, one port of the two-position three-way solenoid directional valve is in communication with a rod cavity of the oil hydraulic cylinder, and another port of the two-position three-way solenoid directional valve is in communication with the oil tank;
an accumulator, where the accumulator is in communication with a rodless cavity of the oil hydraulic cylinder, and the accumulator is used for impacting the water hydraulic cylinder through the oil hydraulic cylinder; and
a pressurization mechanism, where one end of the pressurization mechanism is in communication with the oil tank, and another end of the pressurization mechanism is in communication with the accumulator, and the pressurization mechanism is used for pressurizing the accumulator.

In an embodiment, the pressurization mechanism includes:
a booster cylinder, where a big piston and a small piston are arranged in the booster cylinder, the big piston and the small piston are coaxially and fixedly arranged through a connecting shaft, a small piston end of the booster cylinder is in communication with the accumulator, and the small piston end of the booster cylinder is in communication with the oil tank; a third one-way valve is installed between the booster cylinder and the accumulator, and a second one-way valve is installed between the booster cylinder and the oil tank; and
a first hydraulic pump, where an inlet end of the first hydraulic pump is in communication with the oil tank, and an outlet end of the first hydraulic pump is in communication with a three-position four-way solenoid valve, two ports of the three-position four-way solenoid valve are respectively in communication with two sides of the big piston of the booster cylinder, and a last port of the three-position four-way solenoid valve is in communication with the oil tank.

In an embodiment, a first overflow valve is arranged between the oil tank and the three-position four-way solenoid valve, and the first overflow valve is arranged in parallel with the first hydraulic pump.

In an embodiment, a second overflow valve is arranged between the oil tank and the two-position three-way solenoid directional valve, and the second overflow valve is arranged in parallel with the second hydraulic pump.

In an embodiment, a pressure gauge is installed on a pipeline between the accumulator and the oil hydraulic cylinder.

In an embodiment, the impact device further includes:
a pressure relief circuit, where the pressure relief circuit is arranged in parallel with the pressurization mechanism, one end of the pressure relief circuit is communicated between the accumulator and the oil hydraulic cylinder, and another end of the pressure relief circuit is communicated between the second hydraulic pump and the oil tank.

In an embodiment, the pressure relief circuit includes a stop valve and a third overflow valve installed on a pipeline, and the stop valve and the third overflow valve are arranged in parallel.

In an embodiment, the sealed container is screwed on the water hydraulic cylinder, and an O-ring seal is arranged between the sealed container and the water hydraulic cylinder; and the helium mass spectrometer leak detector is detachably installed in a helium detection port of the sealed container.

In an embodiment, a sleeve is arranged between the piston rod of the oil hydraulic cylinder and the piston rod of the water hydraulic cylinder, and two ends of the sleeve are in interference fit with the piston rod of the oil hydraulic cylinder and the piston rod of the water hydraulic cylinder respectively.

Compared with the prior art, the disclosure has the following advantages and technical effects.

The present disclosure adopts the accumulator as the pressure power source, which may provide fast, stable and large-flow oil, thereby solving the problem that the pressure and flow of the common hydraulic pump may not meet the test requirements, and ensuring the stability during the test. Compared with the conventional method of generating impact by dropping a heavy hammer, the disclosure may accurately control the magnitude of the impact generated by the pressure of the accumulator, which is safe and reliable.

The present disclosure may generate a large impact range. When a large impact occurs, helium is used as the detection gas, which is safe and reliable, so no explosion occurs when the impact is large. Moreover, helium has a wide detection range. For micro-leakage, using helium as the detection gas will not block the micro-leakage hole. Moreover, helium may rapidly diffuse to detect the hydraulic cylinder with micro-leakage.

### BRIEF DESCRIPTION OF THE DRAWINGS

In order to explain the embodiments of the present disclosure or the technical solution in the prior art more clearly, the drawings needed in the embodiments will be briefly introduced on. Apparently, the drawings in the following description are only some embodiments of the present disclosure. For one of ordinary skill in the art, other drawings may be obtained according to these drawings without paying creative effort:

FIG. 1 is a schematic diagram of a test bench for impact leakage detection of a water hydraulic cylinder based on helium gas detection according to the present disclosure.

FIG. 2 is a schematic diagram of a connection between a sealed container and a water hydraulic cylinder according to the present disclosure.

FIG. 3 is a schematic structural diagram of a test bench body according to the present disclosure.

### DETAILED DESCRIPTION OF THE EMBODIMENTS

It should be noted that the embodiments in the present disclosure and the features in the embodiments may be combined with each other without conflict. The described embodiments are only a part of the embodiments of the present disclosure, not all the embodiments. All other embodiments obtained by one of ordinary skill in the art without creative effort belong to the scope of protection of the present disclosure. The present disclosure will be described in detail with reference to the attached drawings and embodiments.

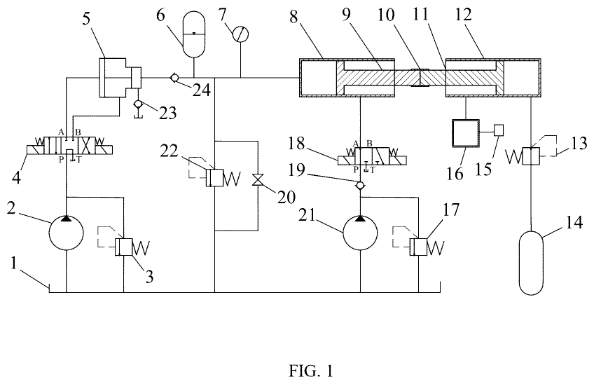

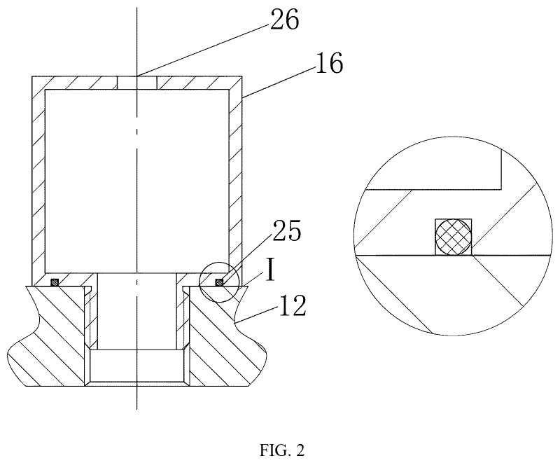

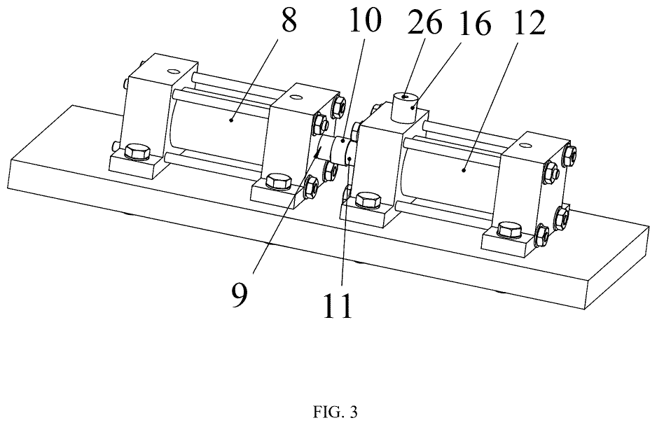

As shown in FIG. 1 to FIG. 3, the disclosure provides a test bench for impact leakage detection of a water hydraulic cylinder based on helium gas detection, includes a test bench body, a water hydraulic cylinder 12, a helium bottle 14, a sealed container 16, and an impact device.

The water hydraulic cylinder 12 is detachably installed on the test bench body.

The outlet end of the helium bottle 14 is in communication with the rodless cavity of the water hydraulic cylinder 12, and a pressure reducing valve 13 is installed between the helium bottle 14 and the water hydraulic cylinder 12.

The sealed container 16 is detachably installed at a rod cavity of the water hydraulic cylinder 12, and a helium mass spectrometer leak detector 15 is installed on the sealed container 16.

The impact device is fixedly installed on the test bench body and connected to the piston rod of the water hydraulic cylinder 12, and the impact device is used for providing impact power for the water hydraulic cylinder 12.

In an embodiment, the impact device includes an oil tank 1, an oil hydraulic cylinder 8, a second hydraulic pump 21, an accumulator 6, and a pressurization mechanism.

The oil hydraulic cylinder 8 is detachably installed on the test bench body, and the piston rod of the oil hydraulic cylinder 8 is connected to the piston rod of the water hydraulic cylinder 12.

The inlet end of the second hydraulic pump 21 is in communication with the oil tank 1, and the outlet end of the second hydraulic pump 21 is sequentially provided with a first one-way valve 19 and a two-position three-way solenoid directional valve 18, one port of the two-position three-way solenoid directional valve 18 is in communication with the rod cavity of the oil hydraulic cylinder 8, and the other port of the two-position three-way solenoid directional valve 18 is in communication with the oil tank 1.

The accumulator 6 is in communication with the rodless cavity of the oil hydraulic cylinder 8, and the accumulator 6 is used for impacting the water hydraulic cylinder 12 through the oil hydraulic cylinder 8.

One end of the pressurization mechanism is in communication with the oil tank 1, and the other end of the pressurization mechanism is in communication with the accumulator 6, and the pressurization mechanism is used for pressurizing the accumulator 6.

In an embodiment, the pressurization mechanism includes a booster cylinder 5 and a first hydraulic pump 2.

A big piston and a small piston are arranged in the booster cylinder 5, the big piston and the small piston are coaxially and fixedly arranged through a connecting shaft. The small piston end of the booster cylinder 5 is in communication with the accumulator 6, and the small piston end of the booster cylinder 5 is in communication with the oil tank 1. A third one-way valve 24 is installed between the booster cylinder 5 and the accumulator 6, and a second one-way valve 23 is installed between the booster cylinder 5 and the oil tank 1.

The inlet end of the first hydraulic pump 2 is in communication with the oil tank 1, and the outlet end of the first hydraulic pump 2 is in communication with a three-position four-way solenoid valve 4, two ports of the three-position four-way solenoid valve 4 are respectively in communication with two sides of the big piston of the booster cylinder 5, and the last port of the three-position four-way solenoid valve 4 is in communication with the oil tank 1.

In an embodiment, a first overflow valve 3 is arranged between the oil tank 1 and the three-position four-way solenoid valve 4, and the first overflow valve 3 is arranged in parallel with the first hydraulic pump 2.

In an embodiment, a second overflow valve 17 is arranged between the oil tank 1 and the two-position three-way solenoid directional valve 18, and the second overflow valve 17 is arranged in parallel with the second hydraulic pump 21.

In an embodiment, a pressure gauge 7 is installed on the pipeline between the accumulator 6 and the oil hydraulic cylinder 8.

In an embodiment, the impact device also includes a pressure relief circuit, and the pressure relief circuit is arranged in parallel with the pressurization mechanism, one end of the pressure relief circuit is communicated between the accumulator 6 and the oil hydraulic cylinder 8, and the other end of the pressure relief circuit is communicated between the second hydraulic pump 21 and the oil tank 1.

In an embodiment, the pressure relief circuit includes a stop valve 20 and a third overflow valve 22 installed on the pipeline, and the stop valve 20 and the third overflow valve 22 are arranged in parallel.

In an embodiment, the sealed container 16 is screwed on the water hydraulic cylinder 12, and an O-ring seal 25 is arranged between the sealed container 16 and the water hydraulic cylinder 12. The helium mass spectrometer leak detector 15 is detachably installed in the helium detection port 26 of the sealed container 16.

In an embodiment, a sleeve 10 is arranged between the piston rod 9 of the oil hydraulic cylinder 8 and the piston rod 11 of the water hydraulic cylinder 12, and two ends of the sleeve 10 are in interference fit with the piston rod 9 of the oil hydraulic cylinder 8 and the piston rod 11 of the water hydraulic cylinder 12 respectively.

A use method of the test bench for the impact leakage detection of the water hydraulic cylinder based on the helium gas detection provided by the disclosure is as follows.

The two-position three-way solenoid directional valve is placed in the left position, and the second hydraulic pump 21 is turned on to inject hydraulic oil into the rod cavity of the hydraulic cylinder 8 to move the piston rod 9 to the far left and drive the piston rod 11. The helium bottle 14 is opened to enable helium to flow from the helium bottle 14 into the rodless cavity of the water hydraulic cylinder 12 through the pressure reducing valve 13, so that the right cavity of the water hydraulic cylinder 12 is filled with helium at a certain pressure. The first hydraulic pump 2 is turned on, and the three-position four-way solenoid directional valve is placed in the right position, so that the pistons of the booster cylinder 5 move to the far left. The right cavity of the booster cylinder 5 sucks oil from the oil tank 1 through the second one-way valve 23, and the oil in the left cavity of the booster cylinder 5 flows back to the oil tank 1 through the three-position four-way solenoid directional valve. Then, the three-position four-way solenoid directional valve is placed in the left position, the piston rod of the booster cylinder 5 starts to move to the right, and the oil will not flow to the oil tank 1 but to the accumulator 6 due to the function of the second one-way valve 23. The pressure gauge 7 measures the pressure in the oil circuit. Due to the existence of the third one-way valve 24, the oil may only be sucked from the oil tank 1 when the pistons of the booster cylinder 5 move to the left, thus avoiding the oil from being sucked from the accumulator 6. The above process is repeated until the accumulator 6 reaches a certain pressure, and the three-position four-way solenoid directional valve is placed in the middle position, so that the first hydraulic pump 2 is unloaded, and the booster cylinder 5 is locked. Then, the two-position three-way solenoid directional valve 18 is placed in the right position, and the accumulator 6 starts to discharge liquid. At this time, the pressure in the right cavity of the oil hydraulic cylinder 8 changes instantly, resulting in an impact. The third overflow valve 22 may prevent the circuit from being damaged by excessive pressure in the oil circuit. The impact will be transmitted from the piston rod 9 to the piston rod 11, and the helium in the right cavity of the water hydraulic cylinder 12 will be impacted. If helium leaks, helium will leak from the right cavity of the water hydraulic cylinder 12 to the left cavity, and then diffuse into the scaled container 16. The helium mass spectrometer leak detector 15 judges whether helium leaks by detecting the concentration of helium in the sealed container 16. When the impact is finished, the stop valve 20 is opened, so that the oil released by the accumulator 6 returns to the oil tank 1.

The present disclosure adopts the accumulator 6 as the pressure power source, which may provide fast, stable and large-flow oil, thereby solving the problem that the pressure and flow of the common hydraulic pump may not meet the test requirements, and ensuring the stability of during test process. Compared with the conventional method of generating impact by dropping a heavy hammer, the disclosure may accurately control the magnitude of the impact generated by the pressure of the accumulator 6, which is safe and reliable. By setting the pressure of the third overflow valve 22, the damage of components caused by excessive impact may be avoided.

Helium has a wide detection range. For micro-leakage, using helium as the detection gas will not block the micro-leakage hole. Moreover, helium may rapidly diffuse to detect the hydraulic cylinder with micro-leakage.

The impact device according to the present disclosure may generate a large impact range. When a large impact occurs, helium is used as the detection gas, which is safe and reliable, so no explosion occurs when the impact is large. Moreover, by using the booster cylinder 5, the problem that the pressure of ordinary pump may not meet the test requirements is avoided, thereby increasing the pressure inside accumulator 6 and increasing the impact generated. The three-position four-way solenoid valve 4 has a fast response speed, and the pressure may be quickly increased to a given value by controlling the three-position four-way solenoid valve 4. The impact is achieved through the two-position three-way solenoid directional valve 18, which facilitates timely detection and data recording.

After the impact, by opening the stop valve 20, the oil may be recovered in time to avoid unnecessary waste. After the test is completed, helium may be recovered in time for use in the next test, thereby conserving resources conservation.

The above is only the preferred embodiment of the present disclosure, but the protection scope of the present disclosure is not limited to this. Any change or replacement that may be easily thought of by a person skilled in the art within the technical scope disclosed in the present disclosure should be included in the protection scope of the present disclosure. Therefore, the protection scope of the present disclosure should be based on the protection scope of the claims.

What is claimed is:

1. A test bench for impact leakage detection of a water hydraulic cylinder based on helium gas detection, comprising:
a test bench body;
a water hydraulic cylinder, wherein the water hydraulic cylinder is detachably installed on the test bench body;
a helium bottle, wherein an outlet end of the helium bottle is in communication with a rodless cavity of the water hydraulic cylinder, and a pressure reducing valve is installed between the helium bottle and the water hydraulic cylinder;
a sealed container, wherein the sealed container is detachably installed at a rod cavity of the water hydraulic cylinder, and a helium mass spectrometer leak detector is installed on the sealed container; and
an impact device, wherein the impact device is fixedly installed on the test bench body, and the impact device is connected to a piston rod of the water hydraulic cylinder, and the impact device is used for providing impact power for the water hydraulic cylinder.

2. The test bench for the impact leakage detection of the water hydraulic cylinder based on the helium gas detection according to claim 1, wherein the impact device comprises:
an oil tank;
an oil hydraulic cylinder, wherein the oil hydraulic cylinder is detachably installed on the test bench body, and a piston rod of the oil hydraulic cylinder is connected to the piston rod of the water hydraulic cylinder;
a second hydraulic pump, wherein an inlet end of the second hydraulic pump is in communication with the oil tank, an outlet end of the second hydraulic pump is sequentially provided with a first one-way valve and a two-position three-way solenoid directional valve, one port of the two-position three-way solenoid directional valve is in communication with a rod cavity of the oil hydraulic cylinder, and another port of the two-position three-way solenoid directional valve is in communication with the oil tank;
an accumulator, wherein the accumulator is in communication with a rodless cavity of the oil hydraulic cylinder, and the accumulator is used for impacting the water hydraulic cylinder through the oil hydraulic cylinder; and
a pressurization mechanism, wherein one end of the pressurization mechanism is in communication with the oil tank, and another end of the pressurization mechanism is in communication with the accumulator, and the pressurization mechanism is used for pressurizing the accumulator.

3. The test bench for the impact leakage detection of the water hydraulic cylinder based on the helium gas detection according to claim 2, wherein the pressurization mechanism comprises:
a booster cylinder, wherein a big piston and a small piston are arranged in the booster cylinder, the big piston and the small piston are coaxially and fixedly arranged through a connecting shaft, a small piston end of the booster cylinder is in communication with the accumulator, and the small piston end of the booster cylinder is in communication with the oil tank; a third one-way valve is installed between the booster cylinder and the accumulator, and a second one-way valve is installed between the booster cylinder and the oil tank; and
a first hydraulic pump, wherein an inlet end of the first hydraulic pump is in communication with the oil tank, and an outlet end of the first hydraulic pump is in communication with a three-position four-way solenoid valve, two ports of the three-position four-way solenoid valve are respectively in communication with two sides of the big piston of the booster cylinder, and a last port of the three-position four-way solenoid valve is in communication with the oil tank.

4. The test bench for the impact leakage detection of the water hydraulic cylinder based on the helium gas detection according to claim 3, wherein a first overflow valve is arranged between the oil tank and the three-position four-way solenoid valve, and the first overflow valve is arranged in parallel with the first hydraulic pump.

5. The test bench for the impact leakage detection of the water hydraulic cylinder based on the helium gas detection according to claim 2, wherein a second overflow valve is arranged between the oil tank and the two-position three-way solenoid directional valve, and the second overflow valve is arranged in parallel with the second hydraulic pump.

6. The test bench for the impact leakage detection of the water hydraulic cylinder based on the helium gas detection according to claim 2, wherein a pressure gauge is installed on a pipeline between the accumulator and the oil hydraulic cylinder.

7. The test bench for the impact leakage detection of the water hydraulic cylinder based on the helium gas detection according to claim 6, wherein the impact device further comprises:
a pressure relief circuit, wherein the pressure relief circuit is arranged in parallel with the pressurization mechanism, one end of the pressure relief circuit is communicated between the accumulator and the oil hydraulic cylinder, and another end of the pressure relief circuit is communicated between the second hydraulic pump and the oil tank.

8. The test bench for the impact leakage detection of the water hydraulic cylinder based on the helium gas detection according to claim 7, wherein the pressure relief circuit comprises a stop valve and a third overflow valve installed on a pipeline, and the stop valve and the third overflow valve are arranged in parallel.

9. The test bench for the impact leakage detection of the water hydraulic cylinder based on the helium gas detection according to claim 1, wherein the sealed container is screwed on the water hydraulic cylinder, and an O-ring seal is arranged between the sealed container and the water hydraulic cylinder; and the helium mass spectrometer leak detector is detachably installed in a helium detection port of the sealed container.

10. The test bench for the impact leakage detection of the water hydraulic cylinder based on the helium gas detection according to claim 2, wherein a sleeve is arranged between the piston rod of the oil hydraulic cylinder and the piston rod of the water hydraulic cylinder, and two ends of the sleeve are in interference fit with the piston rod of the oil hydraulic cylinder and the piston rod of the water hydraulic cylinder respectively.
